(19) United States
(12) Patent Application Publication
(10) Pub. No.: US 2008/0065450 A1
(43) Pub. Date: Mar. 13, 2008

(54) Matching a contact to a resource set

(75) Inventors: Kenneth D. Jordan, Groton, MA (US); Lawrence Johnson, Sudbury, MA (US); Michael P. Lepore, Marlborough, MA (US); Paul Schechinger, Londonderry, NH (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/520,333

(22) Filed: Sep. 13, 2006

(51) Int. Cl. G06F 9/46

(52) U.S. Cl. 705/8

(57) ABSTRACT

In one embodiment, a method can include: (i) receiving a new contact or resource availability indication in a contact center; (ii) matching one or more resources in response to an expressed need of the new contact using an aggregate of predetermined characteristics of the one or more resources; and (iii) arranging a session for communication between the new contact and at least one of the one or more resources. The one or more resources can include people or agents, and the session for communication can include a conference call, for example.

### BACKGROUND

Embodiments of the present invention relate in general to matching contacts with resources or agents and, more specifically, to systems and methods for matching a contact to a set of agents for meeting the needs of the contact.

Traditional contact centers include time-division multiplexing (TDM) call centers. More modern contact centers employ multimedia, that may be contacted via one or more such media (e.g., using call numbers, e-mail, chat, etc.), and can include internet protocol (IP) contact centers. Contact centers typically try to find one agent who is the best match for the needs of a single new contact. Each new contact may be assigned to a set of queues, and each of these queues can take into account a set of available agents. However, this conventional method of selecting and routing to a single agent may only satisfy a subset of the contact's needs and may not be sufficient, and the contact's needs may only be partially met.

### OVERVIEW

In one embodiment, a method can include: (i) receiving a new contact or resource availability indication in a contact center; (ii) matching one or more resources in response to an expressed need of the new contact using an aggregate of predetermined characteristics of the one or more resources; and (iii) arranging a session for communication between the new contact and at least one of the one or more resources. The one or more resources can include people or agents, and the session for communication can include a conference call, for example.

In another embodiment, an apparatus can include: (i) an input of a contact center, where the input can receive a new contact or resource availability indication; (ii) logic configured to match one or more resources in response to an expressed need of the new contact, wherein the logic uses an aggregate of predetermined characteristics of the one or more resources; and (iii) logic configured to arrange a session for communication between the new contact and at least one of the one or more resources.

### BRIEF DESCRIPTION OF THE DRAWINGS

FIG. 1 depicts an example contact center system.

FIG. 2 depicts an example of predetermined characteristics for resource matching.

FIG. 3 depicts an example block diagram for a matching and conference arrangement flow.

FIG. 4 depicts an example resource matching algorithm flow.

FIG. 5 depicts a simplified flow chart of a method of matching resources to new contact needs.

### DESCRIPTION OF EXAMPLE EMBODIMENTS

Particular embodiments can provide a system and method for allowing a contact center to find a suitable set of resources (e.g., agents) that can appropriately satisfy expressed needs of a particular contact. Thus, by using a set of agents, as opposed to a single agent, a limited skill set of each agent can effectively be aggregated to provide a more appropriate level of agent matching and/or support for the contact.

Advantages of particular embodiments include a contact center having more complete and improved matching of contact needs, as compared to conventional approaches, by matching to a set of available agents and utilizing an aggregate skill and/or attribute set of the agents. Particular embodiments can allow the contact center to find an appropriate set of agents (i.e., more than one agent, as may be necessary) to satisfy the expressed needs of the contact. This approach can be based on a data driven rules-based routing or matching algorithm and pre-configured data describing the skills and/or attributes of agents, as well as real-time data describing or expressing the needs of the contact.

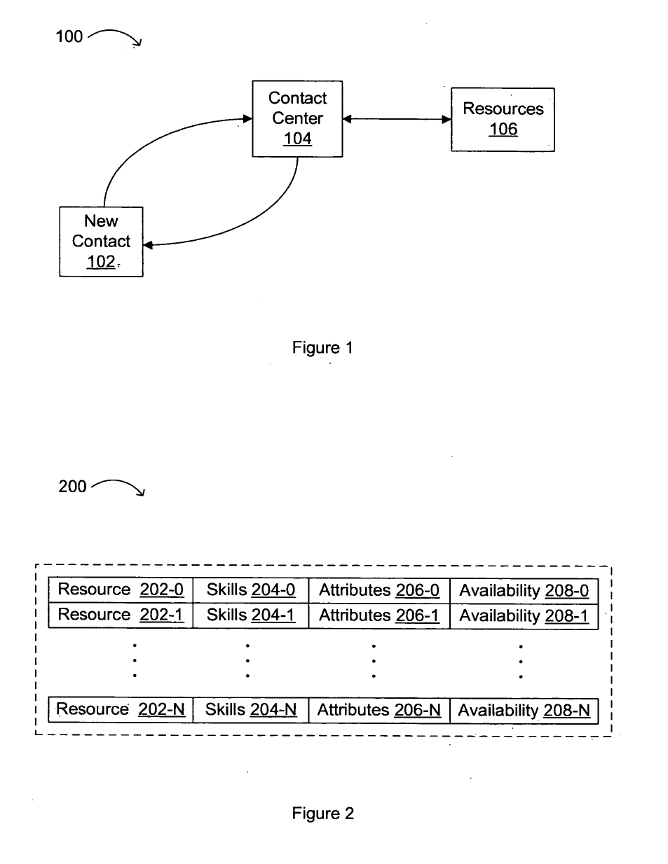

Referring now to FIG. 1, an example contact center system is indicated by the general reference character 100. New contact 102 can reach contact center 104, and may express certain needs to contact center 104. In response, contact center 104 can arrange for one or more of resources 106 to satisfy the needs of the new contact. Further, particular embodiments can allow for an aggregation of predetermined characteristics, such as skill sets and/or attributes in order to arrange for servicing the expressed needs of new contact 102.

In addition, resources 106 can include actual people (e.g., agents), or may include automated processes. Such automated processes can include text-to-speech (TTS), as well as automatic speech recognition, engines. Also in particular embodiments, system 100 can take into account a reserved agent's utilization or other such statistics and/or reports for future routing or matching to new contact decisions. For example, utilization factors can indicate an agent's ability to “multitask” (e.g., handle ten e-mails while participating in a teleconference) and work on multiple contacts at one time. Further, agent queues may be organized by such reporting or utilization considerations.

Generally, agents may be associated with a set of queues, and an incoming contact may be assigned to one or more of those queues. Each agent may have a set of predetermined characteristics (e.g., skills and/or attributes) associated therewith. For example, agent skills may include “persistent” qualities, such as language capability, educational degrees, and areas of knowledge or expertise. Agent attributes can include more “transient” qualities, such as an emotional state or a location of the agent, for example.

Similarly, a contact's needs may be described or expressed as a set of “needed” or desired skills and/or attributes. Such skills and/or attributes associated with a particular queue may be the sum or aggregate of those skills and/or attributes for the agents assigned to that queue, for example. Referring now to FIG. 2, an example of predetermined characteristics for resource matching is indicated by the general reference character 200. Each resource can have certain fields coupled thereto in order to facilitate a search for matching particular predetermined characteristics to fulfill expressed contact needs.

For example, resource 202-0 can have skills 204-0, attributes 206-0, and an availability indication 208-0. Similarly, resource 202-1 can have skills 204-1, attributes 206-1, and an availability indication 208-1, and so on through resource 202-N with skills 204-N, attributes 206-N, and availability indication 208-N. Of course, additional fields or fewer fields can be used, depending on the particular application.

In particular embodiments, a routing algorithm can be rules-driven where the rules may be pre-configured and/or dynamically provided during system execution. A rule may describe what the contact desires, and how to match the contact's desired skills and/or attributes to the available skills and/or attributes for the agents. This matching can include those skills and/or attributes that are considered more important by the contact, as well as those merely considered optional by the contact. In this fashion, a more complete match can be made between the contact and one or more agents or resources.

Using pre-configured rules and/or “real-time” or dynamically provided rules, as well as historical data provided by a contact center solution, the routing algorithm can select a suitable number of agents who are available, and when all of their skills and/or attributes are combined, can best meet the contact needs. Given this set of agents, the contact center solution can then “reserve” and/or “conference” some or all of those agents with that contact. Further, such conferences can include any suitable form of media (e.g., web-based, video, audio, etc.).

In particular embodiments, agents who are only reserved (i.e., not conferenced in yet) could be added to the conference at a later time as may be needed by the other agents, or as indicated by the system itself (e.g., based on an external action or trigger during the agent or customer interaction). For example, a voice analyzer already conferenced into the call may indicate a stressful customer interaction to the system, and the system (e.g., based on analysis of the voice analyzer's information) may add a reserved recording resource to the call. In any event, the matching algorithm may factor in these reserved agents as partially utilized so as to provide a more evenly-balanced work load across agents.

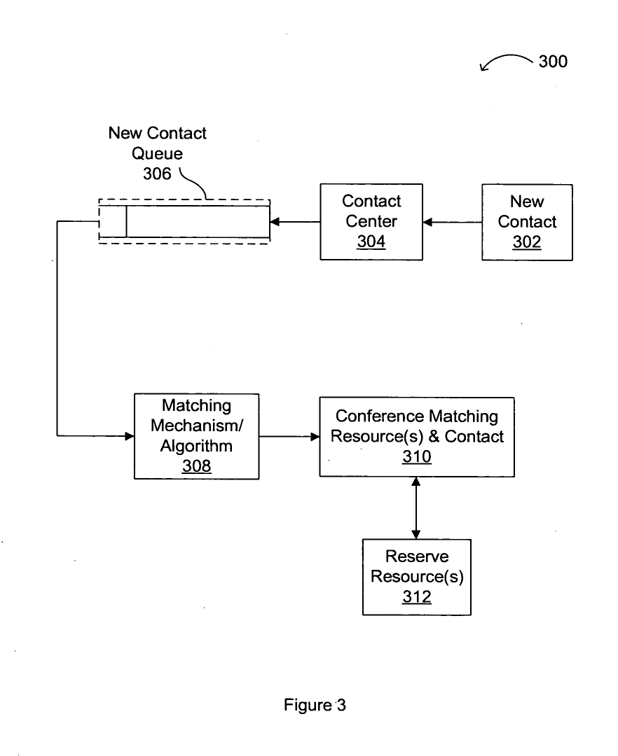

Referring now to FIG. 3, an example block diagram for a matching and conference arrangement flow is indicated by the general reference character 300. New contact 302 can reach contact center 304. The new contact may then enter new contact queue 306. New contact queue 306 may be ordered or a simple first-in first-out (FIFO) structure, for example. After leaving new contact queue 306, matching mechanism/algorithm 308 can be activated. Alternatively new contact queue 306 can be positioned after matching mechanism/algorithm 308, for example.

Matching mechanism/algorithm 308 can include performing comparisons with an aggregation of predetermined characteristics, and can include real-time or historic agent performance data, to find an appropriate set of resources or agents, as discussed above. Once a suitable set of resources or agents is identified, a conference matching resources and the new contact (310) can be established. For example, a call to join the conference can be placed to each of the agents or resources selected. Further, some resources or agents can be held in reserve (312), such as when it is not clear that a certain agent may be fully required in a particular conference in order to address the expressed needs of the new contact.

In particular embodiments, one or more of the selected agents may be made aware of the other agents and/or resources to facilitate conference inclusion with the contact as may be needed. Also in particular embodiments, a system can determine whether to conference in all agents, or only some, while reserving the others. For example, such determinations can be made based on matching rules (e.g., contact needs comparisons to predetermined agent or resource characteristics) and/or by having certain characteristics marked as “optional” where an agent selected based on characteristics marked as option may only be reserved.

In an example application, a Massachusetts customer or contact may be looking for help with both financial investments and taxes in order to make the right decisions. An investment contact center (e.g., Fidelity) may have one set of agents who are trained on financial investments, and another set of agents who are authorized to provide tax advice for certain states. Thus, there may be no single agent available that possesses both financial knowledge and tax knowledge for the state of Massachusetts.

In particular embodiments, a suitable (e.g., substantially minimized) set of agents can be identified. In this example, a financial agent and a tax agent authorized for Massachusetts can be included in the minimum set of agents. The customer can then be placed in a conference with both agents simultaneously. Or, the customer could be connected with only one of the agents, while the other agent is reserved, and the reserved agent may later be added to the conference if the conferenced agent or the customer so requests.

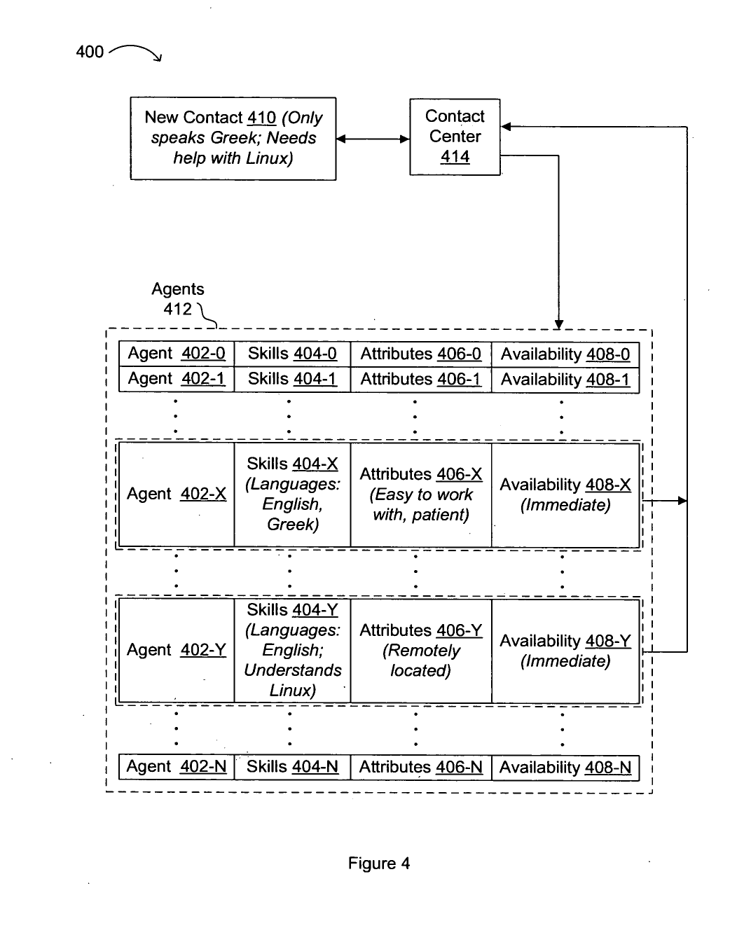

Referring now to FIG. 4, another example resource matching algorithm flow is indicated by the general reference character 400. In this particular example, new contact 410 may express needs of help with Linux while only speaking Greek. Contact center 414 can receive the new contact and the expressed needs. Then, contact center 414 can activate a matching algorithm including accessing a database of information on agents 412.

Agents 412 can include agent 402-0 with skills 404-0, attributes 406-0, and an availability indication 408-0. Similarly, agent 402-1 can have skills 404-1, attributes 406-1, and an availability indication 408-1, so on through resource 402-X with skills 404-X, attributes 406-X, and availability indication 408-X, so on through resource 402-Y with skills 404-Y, attributes 406-Y, and availability indication 408-Y, and so on through resource 402-N with skills 404-N, attributes 406-N, and availability indication 408-N

As shown in this particular example, agent 402-X can have skills 404-X including Greek and English language skills. Agent 402-X can also have attributes 406-X that include being easy to work with and being patient. Finally, agent 402-X can also have an availability indication of “immediate” such that agent 402-X can immediately respond. Thus, agent 402-X has some of the predetermined characteristics for which new contact 410 has expressed needs, but not enough such characteristics to fully address those needs.

In particular embodiments, another one or more agents can have predetermined characteristics aggregated with agent 402-X in order to fully address the expressed needs of new contact 410. For example, agent 402-Y can have skills 404-Y including English language skills, and an understanding of Linux. Agent 402-Y can also have attributes 406-Y that include being remotely located, and agent 402-Y can also have an immediate availability indication. Accordingly, agents 402-X and 402-Y can be selected by the matching algorithm to join a conference or other communication session in order to fully address expressed needs of new contact 410. Of course, a set of more than two agents may be suitable for addressing expressed contact needs in other examples.

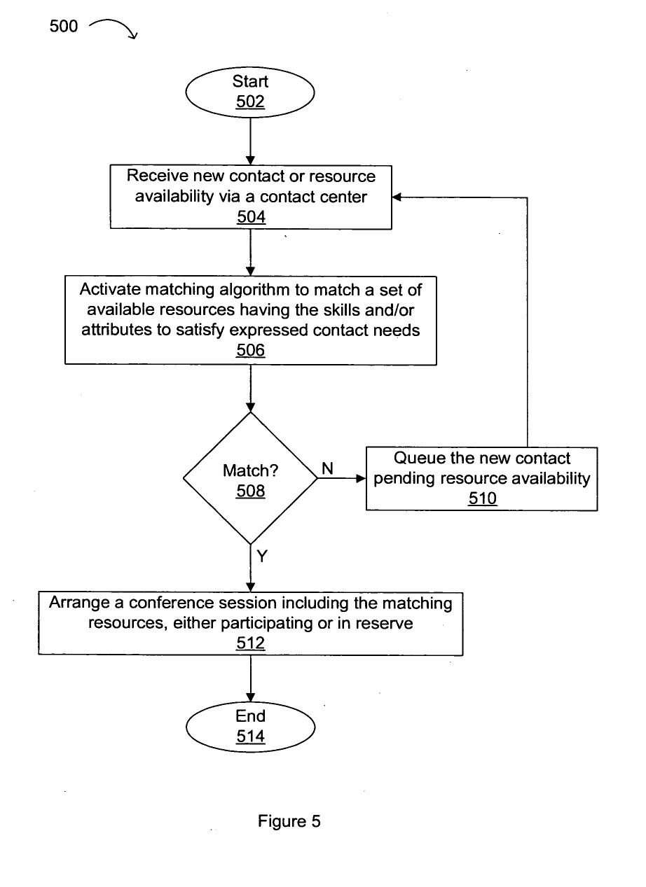

Referring now to FIG. 5, a simplified flow chart of a method of matching resources to new contact needs is indicated by the general reference character 500. The flow can begin (502) and a new contact or resource availability can be received via a contact center (504). Next, a matching algorithm can be activated to match a set of available resources with the skills and/or attributes to satisfy expressed new contact needs (506).

Because of current resource availability, it is possible that no such match is initially found. If no match is found (508), the new contact can be queued pending resource availability (510). Thus, the new contact can remain in the queue (510) until a resource availability indicator is received (504).

However, once a match is found (508), a conference session including the matching resources can be arranged (512) and the flow can complete (514). The conference session, or other appropriate communication session, may have some resources participating, while others are held in reserve. For example, one or two resources or agents may be able to handle the vast majority of the expressed new contact needs, but they may only need a third agent for a particular area of expertise. In this case, the third agent can be held in reserve until requested to join the conference by either the new contact, another of the agents actively participating in the conference, or by the system as a result of analysis based on information presented by the active agents.

In this fashion, an apparatus and/or method can allow a contact center to find a suitable set of resources (e.g., agents) that can appropriately satisfy the needs of a particular contact. Thus, by using a set of agents, as opposed to a single agent, the limited skill sets of each agent can effectively be aggregated to provide a suitable level of agent matching and/or support for the contact.

Although contact centers are primarily described herein, it will be understood that other types of matching and/or resource allocation may be appreciated by persons skilled in the art. For example, any type of matching algorithm amenable to selection of one or more resources for fulfilling expressed needs can be accommodated in accordance with particular embodiments. Further, agents, or other general types of resources (e.g., automated processes) can be employed in accordance with particular embodiments. For example, text-to-speech (TTS) and/or automatic speech recognition engines can be utilized in accordance with particular embodiments.

Although particular embodiments have been described, these embodiments are merely illustrative, and not restrictive of the invention.

Any suitable programming language can be used to implement the routines of embodiments of the present invention including C, C++, Java, assembly language, etc. Different programming techniques can be employed such as procedural or object oriented. The routines can execute on a single processing device or multiple processors. Although the steps, operations, or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

Embodiments of the present invention can be implemented in the form of control logic in software or hardware or a combination of both. The control logic may be stored in an information storage medium, such as a computer-readable medium, as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment”, “particular embodiments,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” “in a particular embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of embodiments of the present invention can be achieved by any means as is known in the art. Further, distributed, or networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as examples, and not as limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method, comprising:
receiving a new contact or resource availability indication in a contact center;
matching one or more resources in response to an expressed need of the new contact using an aggregate of predetermined characteristics of the one or more resources; and
arranging a session for communication between the new contact and at least one of the one or more resources.

2. The method of claim 1, further comprising queuing the new contact until a sufficient availability of the one or more resources is determined.

3. The method of claim 1, wherein the session for communication comprises a conference.

4. The method of claim 3, wherein the arranging the session comprises offering the conference to the one or more resources.

5. The method of claim 4, wherein at least one of the one or more resources is held in reserve.

6. The method of claim 1, wherein at least one of the one or more resources comprises a person or agent.

7. The method of claim 6, further comprising considering a utilization of the person or agent.

8. The method of claim 1, wherein at least one of the one or more resources comprises an automated process.

9. The method of claim 8, wherein the automated process comprises a text-to-speech (TTS) or automatic speech recognition engine.

10. The method of claim 1, wherein the predetermined characteristics comprise skills or attributes.

11. An apparatus, comprising:
an input of a contact center, the input being configured to receive a new contact or resource availability indication;
logic configured to match one or more resources in response to an expressed need of the new contact, wherein the logic uses an aggregate of predetermined characteristics of the one or more resources; and
logic configured to arrange a session for communication between the new contact and at least one of the one or more resources.

12. The apparatus of claim 11, further comprising a queue configured to store the new contact until a sufficient availability of the one or more resources is determined.

13. The apparatus of claim 11, wherein the session for communication comprises a conference.

14. The apparatus of claim 11, wherein at least one of the one or more resources is held in reserve.

15. The apparatus of claim 11, wherein at least one of the one or more resources comprises a person or agent.

16. The apparatus of claim 15, further comprising logic configured to consider a utilization of the person or agent.

17. The apparatus of claim 11, wherein at least one of the one or more resources comprises an automated process.

18. The apparatus of claim 17, wherein the automated process comprises a text-to-speech (TTS) or automatic speech recognition engine.

19. The apparatus of claim 11, wherein the predetermined characteristics comprise skills or attributes.

20. A means for contact matching, comprising:
a means for receiving a new contact or resource availability indication in a contact center;
a means for matching one or more resources in response to an expressed need of the new contact using an aggregate of predetermined characteristics of the one or more resources; and
a means for arranging a session for communication between the new contact and at least one of the one or more resources.
